(19) United States
(12) Patent Application Publication
(10) Pub. No.: US 2024/0129855 A1
(43) Pub. Date: Apr. 18, 2024

(54) Energy management in Wi-Fi networks and smart homes

(71) Applicant: Plume Design, Inc., Palo Alto, CA (US)

(72) Inventors: David Huynh, Palo Alto, CA (US); Jared Gregory, Raleigh, NC (US); Crystal Wai, Redwood City, CA (US)

(21) Appl. No.: 17/967,233

(22) Filed: Oct. 17, 2022

(51) Int. Cl. H04W 52/02; H04L 12/28

(52) U.S. Cl. CPC H04W 52/0274; H04L 12/282; H04W 84/12

(57) ABSTRACT

Systems and methods include receiving data from a plurality of locations with the data related to one or more smart devices operating at a respective location of the plurality of locations; determining energy usage at the plurality of locations based on the data; and providing a dashboard with a graphical user interface (GUI) visualizing the energy usage based on geographic location of the plurality of locations. The data can further include a device type of the one or more smart devices with the device type determined by a local network at the respective location. The method can further include providing a visualization based on the device type of the one or more smart devices, in a determined region based on the geographic location.

### FIELD OF THE DISCLOSURE

The present disclosure generally relates to wireless networking systems and methods. More particularly, the present disclosure relates to systems and methods for energy management in Wi-Fi networks and smart homes.

### BACKGROUND OF THE DISCLOSURE

Energy efficiency is an important topic for a variety of reasons, including, for example, geopolitical concerns, climate change, green energy, and the like. This is also important as energy use continues to rise based various factors, including, for example, larger swings in temperature resulting in higher heating and air conditioning usage, movement towards electric vehicles, higher compute resource usage, proliferation of smart devices, and the like. It is important as more and more devices are deployed in smart homes that such devices seek to provide energy efficiency. Various locations have electric grids that at near, at, or even beyond capacity. Utility companies in such situations ask their users to reduce usage during peak times. This approach requires the end customer activity participate and often this is difficult to achieve, results in less than full participation, etc. There needs to be automation when it comes to conserving energy. In particular, with the rise of smart homes and smart Wi-Fi networks, there is a vast amount of data being provided to cloud services that can be leveraged by communication service providers (CSPs), utility companies, and the like to implement energy conservation strategies.

### BRIEF SUMMARY OF THE DISCLOSURE

The present disclosure relates to systems and methods for energy management in Wi-Fi networks and smart homes. In particular, the present disclosure utilizes a middleware layer that can be implemented on Wi-Fi devices, Internet of Things (IoT) devices, and the like to gather a vast amount of data about the home and the current status, e.g., provided to a cloud service. This data can be used to implement various energy conservation strategies, such as lowering power on the Wi-Fi devices, IoT devices, etc., controlling smart devices in the home, providing analytics and forecasting to utility companies, providing analytics and forecasting to end users, and the like.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a network diagram of various Wi-Fi network topologies for connectivity to the Internet.

FIG. 2A is a network diagram of the Wi-Fi network with cloud-based control.

FIG. 2B is a network diagram of an example implementation of the Wi-Fi network, as a distributed Wi-Fi network in a tree topology.

FIG. 3A is a block diagram of functional components of the access points, mesh nodes, repeaters, etc., in the Wi-Fi networks of FIG. 1.

FIG. 3B is a logical diagram of the access points, mesh nodes, repeaters, etc. with a middleware layer to enable operation with the cloud service.

FIG. 4 is a block diagram of functional components of a server, a Wi-Fi client device, or a user device that may be used with the Wi-Fi network of FIG. 1 and/or the cloud-based control of FIG. 2A.

FIGS. 5A and 5B are screenshots of a mobile app illustrating a motion configuration graphical user interface (GUI) (FIG. 5A) and a motion visualization GUI (FIG. 5B).

FIGS. 5C and 5D are screenshots of the app illustrating a device assignment process.

FIGS. 5E and 5F are screenshots of the app illustrating people at home.

FIG. 6 is a network diagram of a portion of a network associated with a network operator.

FIG. 7 is a diagram of a fixed wireless access system for wired and/or wireless connectivity.

FIG. 8 is a flowchart of a process for providing analytics related to energy consumption.

### DETAILED DESCRIPTION OF THE DISCLOSURE

Again, the present disclosure relates to systems and methods for energy management in Wi-Fi networks and smart homes. In particular, the present disclosure utilizes a middleware layer that can be implemented on Wi-Fi devices, Internet of Things (IoT) devices, and the like to gather a vast amount of data about the home and the current status, e.g., provided to a cloud service. This data can be used to implement various energy conservation strategies, such as lowering power on the Wi-Fi devices, IoT devices, etc., controlling smart devices in the home, providing analytics and forecasting to utility companies, providing analytics and forecasting to end users, and the like.

### § 1.0 WI-FI NETWORK TOPOLOGIES

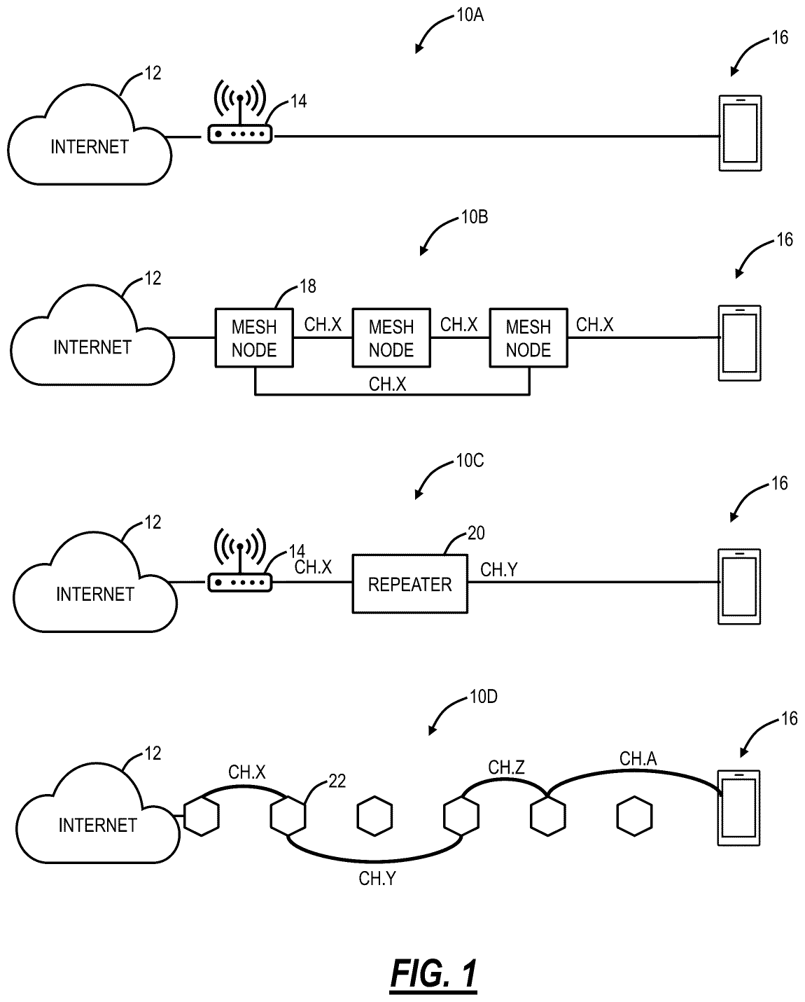

FIG. 1 is a network diagram of various Wi-Fi network 10 (namely Wi-Fi networks 10A-10D) topologies for connectivity to the Internet 12. The Wi-Fi network 10 can operate in accordance with the IEEE 802.11 protocols and variations thereof. The Wi-Fi network 10 is deployed to provide coverage in a physical location, e.g., home, business, store, library, school, park, etc. The differences in the topologies of the Wi-Fi networks 10 are that they provide different scope of physical coverage. As described herein and as known in the art, the Wi-Fi network 10 can be referred to as a network, a system, a Wi-Fi network, a Wi-Fi system, a cloud-based Wi-Fi system, etc. The access points 14 and equivalent (i.e., mesh nodes 18, repeater 20, and devices 22) can be referred to as nodes, access points, Wi-Fi nodes, Wi-Fi access points, etc. The objective of the nodes is to provide network connectivity to Wi-Fi client devices 16 which can be referred to as client devices, user equipment, user devices, clients, Wi-Fi clients, Wi-Fi devices, etc. Note, those skilled in the art will recognize the Wi-Fi client devices 16 can be mobile devices, tablets, computers, consumer electronics, home entertainment devices, televisions, Internet of Things (IoT) devices, or any network-enabled device.

The Wi-Fi network 10A includes a single access point 14, which can be a single, high-powered access point 14, which may be centrally located to serve all Wi-Fi client devices 16 in a location. Of course, a typical location can have several walls, floors, etc. between the single access point 14 and the Wi-Fi client devices 16. Plus, the single access point 14 operates on a single channel (or possible multiple channels with multiple radios), leading to potential interference from neighboring systems. The Wi-Fi network 10B is a Wi-Fi mesh network that solves some of the issues with the single access point 14 by having multiple mesh nodes 18, which distribute the Wi-Fi coverage. Specifically, the Wi-Fi network 10B operates based on the mesh nodes 18 being fully interconnected with one another, sharing a channel such as a channel X between each of the mesh nodes 18 and the Wi-Fi client device 16. That is, the Wi-Fi network 10B is a fully interconnected grid, sharing the same channel, and allowing multiple different paths between the mesh nodes 18 and the Wi-Fi client device 16. However, since the Wi-Fi network 10B uses the same backhaul channel, every hop between source points divides the network capacity by the number of hops taken to deliver the data. For example, if it takes three hops to stream a video to a Wi-Fi client device 16, the Wi-Fi network 10B is left with only ⅓ the capacity.

The Wi-Fi network 10C includes the access point 14 coupled wirelessly to a Wi-Fi repeater 20. The Wi-Fi network 10C with the repeaters 20 is a star topology where there is at most one Wi-Fi repeater 20 between the access point 14 and the Wi-Fi client device 16. From a channel perspective, the access point 14 can communicate to the Wi-Fi repeater 20 on a first channel, Ch. X, and the Wi-Fi repeater 20 can communicate to the Wi-Fi client device 16 on a second channel, Ch. Y. The Wi-Fi network 10C solves the problem with the Wi-Fi mesh network of requiring the same channel for all connections by using a different channel or band for the various hops (note, some hops may use the same channel/band, but it is not required), to prevent slowing down the Wi-Fi speed. One disadvantage of the repeater 20 is that it may have a different service set identifier (SSID), from the access point 14, i.e., effectively different Wi-Fi networks from the perspective of the Wi-Fi client devices 16.

Despite Wi-Fi's popularity and ubiquity, many consumers still experience difficulties with Wi-Fi. The challenges of supplying real-time media applications, like those listed above, put increasing demands on the throughput, latency, jitter, and robustness of Wi-Fi. Studies have shown that broadband access to the Internet through service providers is up 99.9% of the time at high data rates. However, despite the Internet arriving reliably and fast to the edge of consumer's homes, simply distributing the connection across the home via Wi-Fi is much less reliable leading to poor user experience.

Several issues prevent conventional Wi-Fi systems from performing well, including i) interference, ii) congestion, and iii) coverage. For interference, with the growth of Wi-Fi has come the growth of interference between different Wi-Fi networks which overlap. When two networks within range of each other carry high levels of traffic, they interfere with each other, reducing the throughput that either network can achieve. For congestion, within a single Wi-Fi network, there may be several communications sessions running. When several demanding applications are running, such as high-definition video streams, the network can become saturated, leaving insufficient capacity to support the video streams.

For coverage, Wi-Fi signals attenuate with distance and when traveling through walls and other objects. In many environments, such as residences, reliable Wi-Fi service cannot be obtained in all rooms. Even if a basic connection can be obtained in all rooms, many of those locations will have poor performance due to a weak Wi-Fi signal. Various objects in a residence such as walls, doors, mirrors, people, and general clutter all interfere and attenuate Wi-Fi signals leading to slower data rates.

Two general approaches have been tried to improve the performance of conventional Wi-Fi systems, as illustrated in the Wi-Fi networks 1A, 10B, 10C. The first approach (the Wi-Fi network 10A) is to simply build more powerful single access points, in an attempt to cover a location with stronger signal strengths, thereby providing more complete coverage and higher data rates at a given location. However, this approach is limited by both regulatory limits on the allowed transmit power, and by the fundamental laws of nature. The difficulty of making such a powerful access point, whether by increasing the power, or increasing the number of transmit and receive antennas, grows exponentially with the achieved improvement. Practical improvements using these techniques lie in the range of 6 to 12 dB. However, a single additional wall can attenuate by 12 dB. Therefore, despite the huge difficulty and expense to gain 12 dB of the link budget, the resulting system may not be able to transmit through even one additional wall. Any coverage holes that may have existed will still be present, devices that suffer poor throughput will still achieve relatively poor throughput, and the overall system capacity will be only modestly improved. In addition, this approach does nothing to improve the situation with interference and congestion. In fact, by increasing the transmit power, the amount of interference between networks actually goes up.

A second approach is to use repeaters or a mesh of Wi-Fi devices to repeat the Wi-Fi data throughout a location, as illustrated in the Wi-Fi networks 10B, 10C. This approach is a fundamentally better approach to achieving better coverage. By placing even a single repeater 20 in the center of a house, the distance that a single Wi-Fi transmission must traverse can be cut in half, halving also the number of walls that each hop of the Wi-Fi signal must traverse. This can make a change in the link budget of 40 dB or more, a huge change compared to the 6 to 12 dB type improvements that can be obtained by enhancing a single access point as described above. Mesh networks have similar properties as systems using Wi-Fi repeaters 20. A fully interconnected mesh adds the ability for all the mesh nodes 18 to be able to communicate with each other, opening the possibility of packets being delivered via multiple hops following an arbitrary pathway through the network.

The Wi-Fi network 10D includes various Wi-Fi devices 22 that can be interconnected to one another wirelessly (Wi-Fi wireless backhaul links) or wired, in a tree topology where there is one path between the Wi-Fi client device 16 and the gateway (the Wi-Fi device 22 connected to the Internet), but which allows for multiple wireless hops unlike the Wi-Fi repeater network and multiple channels unlike the Wi-Fi mesh network. For example, the Wi-Fi network 10D can use different channels/bands between Wi-Fi devices 22 and between the Wi-Fi client device 16 (e.g., Ch. X, Y, Z, A), and, also, the Wi-Fi system 10 does not necessarily use every Wi-Fi device 22, based on configuration and optimization. The Wi-Fi network 10D is not constrained to a star topology as in the Wi-Fi repeater network which at most allows two wireless hops between the Wi-Fi client device 16 and a gateway. Wi-Fi is a shared, simplex protocol meaning only one conversation between two devices can occur in the network at any given time, and if one device is talking the others need to be listening. By using different Wi-Fi channels, multiple simultaneous conversations can happen simultaneously in the Wi-Fi network 10D. By selecting different Wi-Fi channels between the Wi-Fi devices 22, interference and congestion can be avoided or minimized.

Of note, the systems and methods described herein contemplate operation through any of the Wi-Fi networks 10, including other topologies not explicated described herein. Also, if there are certain aspects of the systems and methods which require multiple nodes in the Wi-Fi network 10, this would exclude the Wi-Fi network 10A.

### § 1.1 Cloud-Based Control

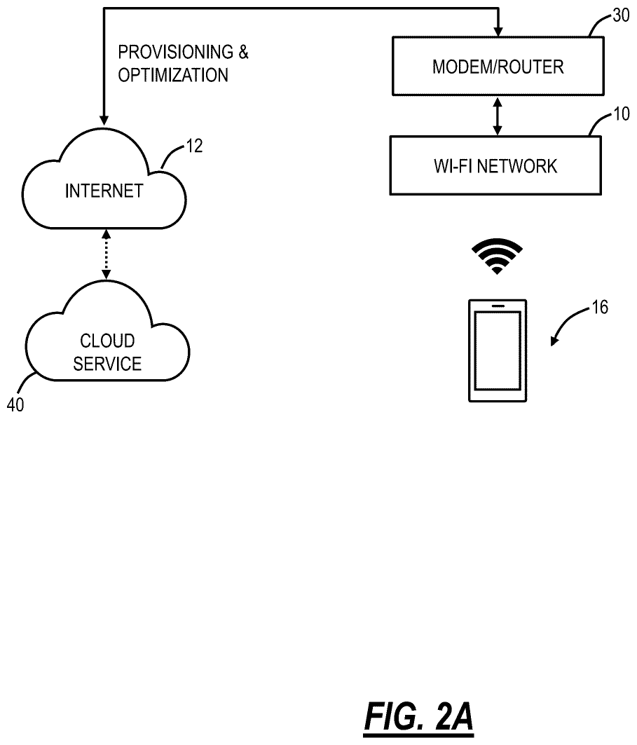

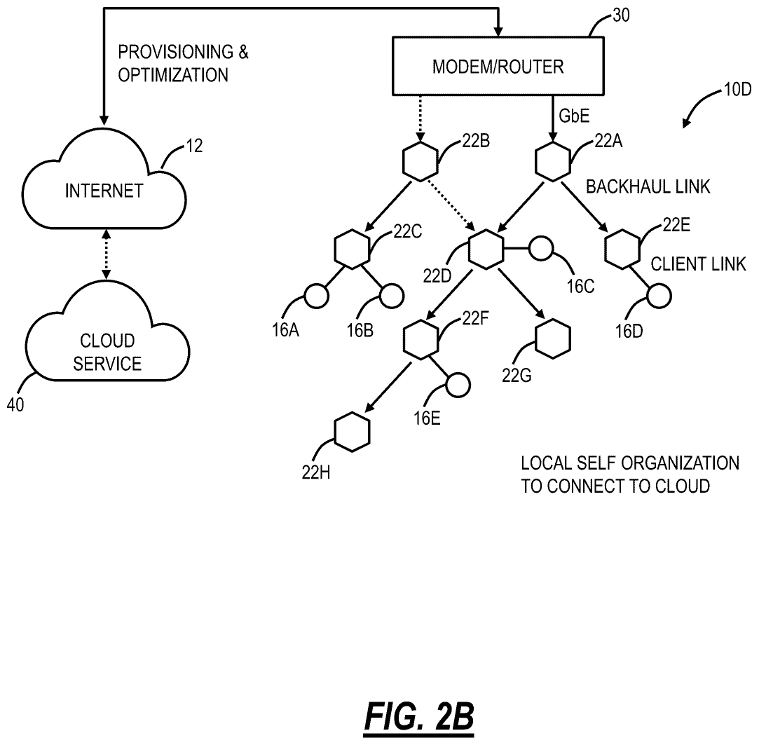

FIG. 2A is a network diagram of the Wi-Fi network 10 with cloud-based control. The Wi-Fi network 10 includes a gateway device which is any of the access points 14, the mesh node 18, or the Wi-Fi device 22 that connects to a modem/router 30 that is connected to the Internet 12. For external network connectivity, the modem/router 30 which can be a cable modem, Digital Subscriber Loop (DSL) modem, cellular interface, or any device providing external network connectivity to the physical location associated with the Wi-Fi network 10. In an embodiment, the Wi-Fi network 10 can include centralized control such as via a cloud service 40 located on the Internet 12 and configured to control multiple Wi-Fi networks 10. The cloud service 40 can receive measurement data, analyze the measurement data, and configure the nodes in the Wi-Fi network 10 based thereon. This cloud-based control is contrasted with a conventional operation that relies on a local configuration such as by logging in locally to an access point.

Of note, cloud-based control can be implemented with any of the Wi-Fi networks 10, with monitoring through the cloud service 40. For example, different vendors can make access points 14, mesh nodes 18, repeaters 20, Wi-Fi devices 22, etc. However, it is possible for unified control via the cloud using standardized techniques for communication with the cloud service 40, such as through a middleware layer. One such example includes OpenSync, sponsored by the Applicant of the present disclosure and described at www.opensync.io/documentation. OpenSync is cloud-agnostic open-source software for the delivery, curation, and management of services for the modern home. That is, this provides standardization of the communication between devices and the cloud service 40. OpenSync acts as silicon, Customer Premises Equipment (CPE), and cloud-agnostic connection between the in-home hardware devices and the cloud service 40. This is used to collect measurements and statistics from the connected Wi-Fi client devices 16 and network management elements, and to enable customized connectivity services.

As described herein, cloud-based management includes reporting of Wi-Fi related performance metrics to the cloud service 40 as well as receiving Wi-Fi-related configuration parameters from the cloud service 40. The systems and methods contemplate use with any Wi-Fi network 10. The cloud service 40 utilizes cloud computing systems and methods to abstract away physical servers, storage, networking, etc. and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase SaaS is sometimes used to describe application programs offered through cloud computing. A common shorthand for a provided cloud computing service (or even an aggregation of all existing cloud services) is “the cloud.”

### § 1.2 Distributed Wi-Fi Network

FIG. 2B is a network diagram of an example implementation the Wi-Fi network 10D, as a distributed Wi-Fi network in a tree topology. The distributed Wi-Fi network 10D includes a plurality of access points 22 (labeled as access points 22A-22H) which can be distributed throughout a location, such as a residence, office, or the like. That is, the distributed Wi-Fi 10D contemplates operation in any physical location where it is inefficient or impractical to service with a single access point, repeaters, or a mesh system. In a typical deployment, the distributed Wi-Fi network 10D can include between 1 to 12 access points or more in a home. A large number of access points 22 (which can also be referred to as nodes in the distributed Wi-Fi system 10) ensures that the distance between any access point 22 is always small, as is the distance to any Wi-Fi client device 16 needing Wi-Fi service. That is, an objective of the distributed Wi-Fi network 10D is for distances between the access points 22 to be of similar size as distances between the Wi-Fi client devices 16 and the associated access point 22. Such small distances ensure that every corner of a consumer's home is well covered by Wi-Fi signals. It also ensures that any given hop in the distributed Wi-Fi network 10D is short and goes through few walls. This results in very strong signal strengths for each hop in the distributed Wi-Fi network 10D, allowing the use of high data rates, and providing robust operation.

For external network connectivity, one or more of the access points 14 can be connected to a modem/router 30 which can be a cable modem, Digital Subscriber Loop (DSL) modem, or any device providing external network connectivity to the physical location associated with the distributed Wi-Fi network 10D.

While providing excellent coverage, a large number of access points 22 (nodes) presents a coordination problem. Getting all the access points 22 configured correctly and communicating efficiently requires centralized control. This control is preferably done via the cloud service 40 that can be reached across the Internet 12 and accessed remotely such as through an application (“app”) running on a client device 16. That is, in an exemplary aspect, the distributed Wi-Fi network 10D includes cloud-based control (with a cloud-based controller or cloud service) to optimize, configure, and monitor the operation of the access points 22 and the Wi-Fi client devices 16. This cloud-based control is contrasted with a conventional operation which relies on a local configuration such as by logging in locally to an access point. In the distributed Wi-Fi network 10D, the control and optimization does not require local login to the access point 22, but rather the Wi-Fi client device 16 communicating with the cloud service 4, such as via a disparate network (a different network than the distributed Wi-Fi network 10D) (e.g., LTE, another Wi-Fi network, etc.).

The access points 22 can include both wireless links and wired links for connectivity. In the example of FIG. 2B, the access point 22A has an exemplary gigabit Ethernet (GbE) wired connection to the modem/router 30. Optionally, the access point 22B also has a wired connection to the modem/router 30, such as for redundancy or load balancing. Also, the access points 22A, 22B can have a wireless connection to the modem/router 30. Additionally, the access points 22A, 22B can have a wireless gateway such as to a cellular provider as is described in detail herein. The access points 22 can have wireless links for client connectivity (referred to as a client link) and for backhaul (referred to as a backhaul link). The distributed Wi-Fi network 10D differs from a conventional Wi-Fi mesh network in that the client links and the backhaul links do not necessarily share the same Wi-Fi channel, thereby reducing interference. That is, the access points 22 can support at least two Wi-Fi wireless channels—which can be used flexibly to serve either the client link or the backhaul link and may have at least one wired port for connectivity to the modem/router 30, or for connection to other devices. In the distributed Wi-Fi network 10D, only a small subset of the access points 22 require direct connectivity to the modem/router 30 with the non-connected access points 22 communicating with the modem/router 30 through the backhaul links back to the connected access points 22A, 22B. Of course, the backhaul links may also be wired Ethernet connections, such as in a location have a wired infrastructure.

### § 2.0 ACCESS POINT

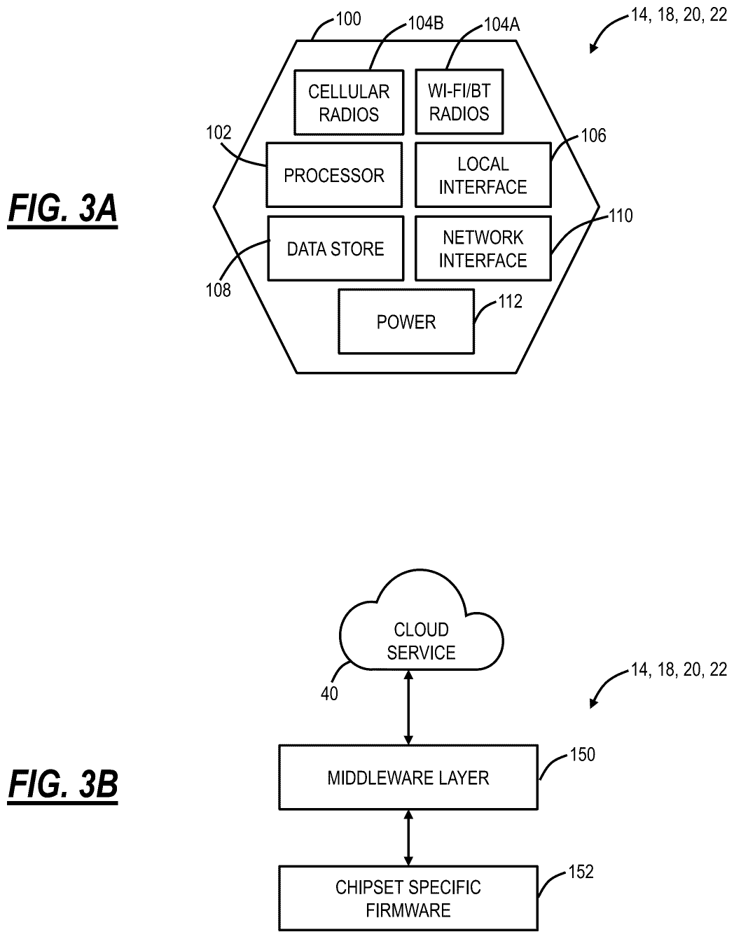

FIG. 3A is a block diagram of functional components of the access points 14, mesh nodes 18, repeaters 20, etc. (“node”) in the Wi-Fi networks 10. The node includes a physical form factor 100 which contains a processor 102, a plurality of radios 104A, 104B, a local interface 106, a data store 108, a network interface 110, and power 112. It should be appreciated by those of ordinary skill in the art that FIG. 3A depicts the node in an oversimplified manner, and a practical embodiment may include additional components and suitably configured processing logic to support features described herein or known or conventional operating features that are not described in detail herein.

In an embodiment, the form factor 100 is a compact physical implementation where the node directly plugs into an electrical socket and is physically supported by the electrical plug connected to the electrical socket. This compact physical implementation is ideal for a large number of nodes distributed throughout a residence. The processor 102 is a hardware device for executing software instructions. The processor 102 can be any custom made or commercially available processor, a central processing unit (CPU), an auxiliary processor among several processors, a semiconductor-based microprocessor (in the form of a microchip or chipset), or generally any device for executing software instructions. When the node is in operation, the processor 102 is configured to execute software stored within memory or the data store 108, to communicate data to and from the memory or the data store 108, and to generally control operations of the access point 14 pursuant to the software instructions. In an embodiment, the processor 102 may include a mobile optimized processor such as optimized for power consumption and mobile applications.

The radios 104A enable wireless communication in the Wi-Fi network 10. The radios 104B can operate according to the IEEE 802.11 standard. The radios 104B support cellular connectivity such as Long-Term Evolution (LTE), 5G, and the like. The radios 104A, 104B include address, control, and/or data connections to enable appropriate communications on the Wi-Fi network 10 and a cellular network, respectively. As described herein, the node can include a plurality of radios 104A to support different links, i.e., backhaul links and client links. The radios 104A can also include Wi-Fi chipsets configured to perform IEEE 802.11 operations. In an embodiment, an optimization can determine the configuration of the radios 104B such as bandwidth, channels, topology, etc. In an embodiment, the node supports dual-band operation simultaneously operating 2.4 GHz and 5 GHz 2×2 MIMO 802.11b/g/n/ac radios having operating bandwidths of 20/40 MHz for 2.4 GHz and 20/40/80 MHz for 5 GHz. For example, the node can support IEEE 802.11AC1200 gigabit Wi-Fi (300+867 Mbps). Also, the node can support additional frequency bands such as 6 GHz, as well as cellular connections. The radios 104B can include cellular chipsets and the like to support fixed wireless access.

Also, the radios 104A, 104B include antennas designed to fit in the form factor 100. An example is described in commonly-assigned U.S. patent Ser. No. 17/857,377, entitled “Highly isolated and barely separated antennas integrated with noise free RF-transparent Printed Circuit Board (PCB) for enhanced radiated sensitivity,” filed Jul. 5, 2022, the contents of which are incorporated by reference in their entirety.

The local interface 106 is configured for local communication to the node and can be either a wired connection or wireless connection such as Bluetooth or the like. Since the node can be configured via the cloud service 40, an onboarding process is required to first establish connectivity for a newly turned on node. In an embodiment, the node can also include the local interface 106 allowing connectivity to a Wi-Fi client device 16 for onboarding to the Wi-Fi network 10 such as through an app on the user device 16. The data store 108 is used to store data. The data store 108 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 108 may incorporate electronic, magnetic, optical, and/or other types of storage media.

The network interface 110 provides wired connectivity to the node. The network interface 110 may be used to enable the node communicates to the modem/router 30. Also, the network interface 110 can be used to provide local connectivity to a Wi-Fi client device 16 or another access point 22. For example, wiring in a device to a node can provide network access to a device that does not support Wi-Fi. In an embodiment, all of the nodes in the Wi-Fi network 10D include the network interface 110. In another embodiment, select nodes, which connect to the modem/router 30 or require local wired connections have the network interface 110. The network interface 110 may include, for example, an Ethernet card or adapter (e.g., 10BaseT, Fast Ethernet, Gigabit Ethernet, 10 GbE). The network interface 110 may include address, control, and/or data connections to enable appropriate communications on the network.

The processor 102 and the data store 108 can include software and/or firmware which essentially controls the operation of the node, data gathering and measurement control, data management, memory management, and communication and control interfaces with the cloud service 40. The processor 102 and the data store 108 may be configured to implement the various processes, algorithms, methods, techniques, etc. described herein.

Also, those skilled in the art will appreciate there can be various physical implementations which are contemplated herein. For example, in some embodiments, the modem/router 30 can be integrated with the access point 14, 18, 22. In other embodiments, just a router can be integrated with the access point 14, 18, 22 with separate connectivity to a modem.

### § 2.1 OpenSync

FIG. 3B is a logical diagram of the access points 14, mesh nodes 18, repeaters 20, etc. (“node”) with a middleware layer 150 to enable operation with the cloud service 40. Of note, the present disclosure contemplates use with any vendor's hardware for the access points 14, mesh nodes 18, repeaters 20, etc. with the addition of the middleware layer 150 that is configured to operate with chipset specific firmware 152 in the node. In an embodiment, the middleware layer 150 is OpenSync, such as describe in www.opensync.io/documentation, the contents of which are incorporated by reference. Again, OpenSync is cloud-agnostic open-source software for the delivery, curation, and management of services for the modern home. That is, this provides standardization of the communication between devices and the cloud service 40. OpenSync acts as silicon, Customer Premises Equipment (CPE), and cloud-agnostic connection between the in-home hardware devices and the cloud service 40.

The middleware layer 150 spans across layers from just above the firmware drivers to the cloud connection for the cloud service 40. The middleware layer 150 is software operates with the following device segments:

Measurements/Statistics/Telemetry
Collecting measurements reported by the low-level drivers
Compiling and pre-processing the measurements into statistics that are uniform across different devices
Presenting the statistics using standardized formats
Preparing the formatted statistics for transfer to the cloud using serialization and packetizing
Communicating the statistics to the cloud using standardized and efficient telemetry

Management/Control
Defining a standard interface for control messaging from the cloud service 40
Providing operations necessary to manage the services, such as onboarding and provisioning
Providing rules-based networking configurations to block, filter, forward, and prioritize the messages
Implementing software to manage the device maintenance functions, including logging, firmware upgrades, and debugging

Cloud-Managed Services
Wi-Fi, including mesh networks that dynamically adapt to their environments
User access management
Cybersecurity
Parental controls
IoT device management
Additional services

Through use of the middleware layer 150, it is possible to have various different vendor devices operate with the cloud service 40. Also, the middleware layer 150 can be on the access points 14, 18, 20, 22, as well as directly on other devices including IoT devices.

### § 2.2 Advanced Device Typing

In an embodiment, the processor 102, the firmware 152, etc. can be configured to implement advanced device typing which provides identification of a specific type of device operating in the home, on the Wi-Fi network 10. This is via a low memory footprint signature pattern matching algorithm that is able to classify a device type, allowing the cloud service 40 to customize performance accordingly. Also, this approach does not rely on the Media Access Control (MAC) address that is unreliable due to the various MAC randomization approaches.

### § 3.0 SERVER AND USER DEVICE

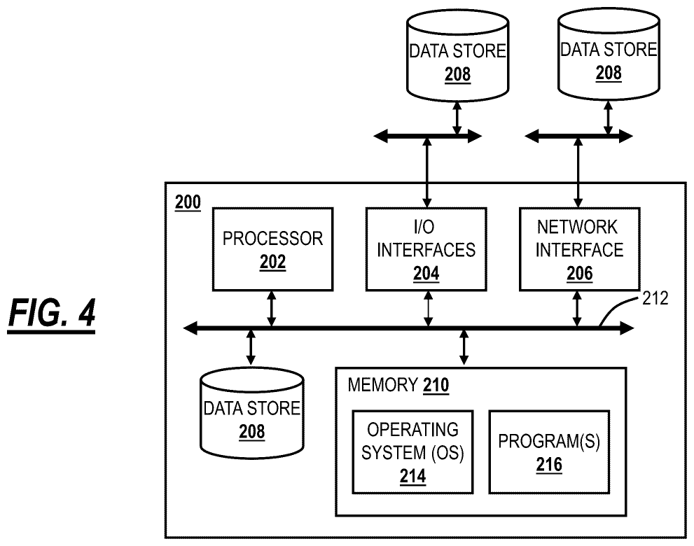

FIG. 4 is a block diagram of functional components of a server 200, a Wi-Fi client device 16, or a user device that may be used with the Wi-Fi network of FIG. 1 or 2B, and/or the cloud-based control of FIG. 2A. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 4 depicts the server 200 in an oversimplified manner, and a practical embodiment may include additional components and suitably configured processing logic to support features described herein or known or conventional operating features that are not described in detail herein.

The components (202, 204, 206, 208, and 210) are communicatively coupled via a local interface 212. The local interface 212 may be, for example, but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a central processing unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components. The user input may be provided via, for example, a keyboard, touchpad, and/or a mouse. System output may be provided via a display device and a printer (not shown). I/O interfaces 204 may include, for example, a serial port, a parallel port, a small computer system interface (SCSI), a serial ATA (SATA), a fibre channel, InfiniBand, iSCSI, a PCI Express interface (PCI-x), an infrared (IR) interface, a radio frequency (RF) interface, and/or a universal serial bus (USB) interface.

The network interface 206 may be used to enable the server 200 to communicate on a network, such as the cloud service 40. The network interface 206 may include, for example, an Ethernet card or adapter (e.g., 10BaseT, Fast Ethernet, Gigabit Ethernet, 10 GbE) or a wireless local area network (WLAN) card or adapter (e.g., 802.11a/b/g/n/ac). The network interface 206 may include address, control, and/or data connections to enable appropriate communications on the network. A data store 208 may be used to store data. The data store 208 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media. In one example, the data store 208 may be located internal to the server 200 such as, for example, an internal hard drive connected to the local interface 212 in the server 200. Additionally, in another embodiment, the data store 208 may be located external to the server 200 such as, for example, an external hard drive connected to the I/O interfaces 204 (e.g., SCSI or USB connection). In a further embodiment, the data store 208 may be connected to the server 200 through a network, such as, for example, a network-attached file server.

The memory 210 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable operating system (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein, such as related to the optimization.

### § 3.1 App

The Wi-Fi networks 10 can be managed by users via a single application (“app”), such as a mobile app, desktop app, etc. In an embodiment, the single app is a mobile app and it is used to set up the Wi-Fi network 10, i.e., security, encryption, SSID, WPA settings, device certificates, etc. In an embodiment, the mobile app is HomePass, available from the Applicant, Plume Design, Inc. Example features of the mobile app include, without limitation:
Wi-Fi hardware is discovered over Bluetooth so the system is up and running in minutes
Intuitive self-install feature, which eliminates the need for technician costs and scheduling
Advanced, automatic identification of devices in the home, complete with icons and names.
View how the network is connecting with a visual topology representation of all access points and connected devices
Creates flawless connectivity across device types, rooms, and complex environments using AI-based optimization
Provides complex network visibility with unique device fingerprinting and speed tests
The cloud-coordinated system harmonizes legacy deployments via OpenSync-compatible hardware
Privacy Manager to temporarily freeze visibility
Parental control tools to set healthy boundaries for access and usage
Guest Manager for access permissions and passwords
Content Manager to filter and block unwanted websites and ads for parents and more
Digital Wellbeing monitors screen time with scheduled freezes and pauses
Online protection from malicious content—Learn more about protecting homes in the connected age
Real-time threat database
IoT anomaly detection and device quarantine
Intrusion detection and outside threat blocking
Motion detection via radio waves to let subscriber-owned devices become sensors to detect expected and unexpected movement
No need to remember to enable the system, the system turns on and off automatically through GPS of primary devices
See movement patterns over the course of time within the mobile app

### § 3.2 Motion Detection

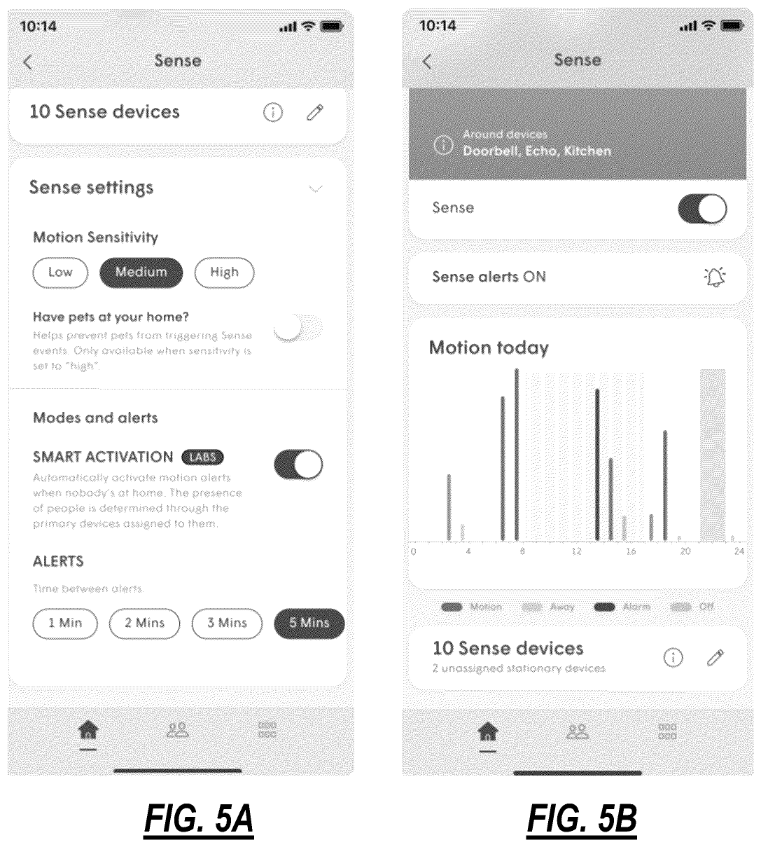

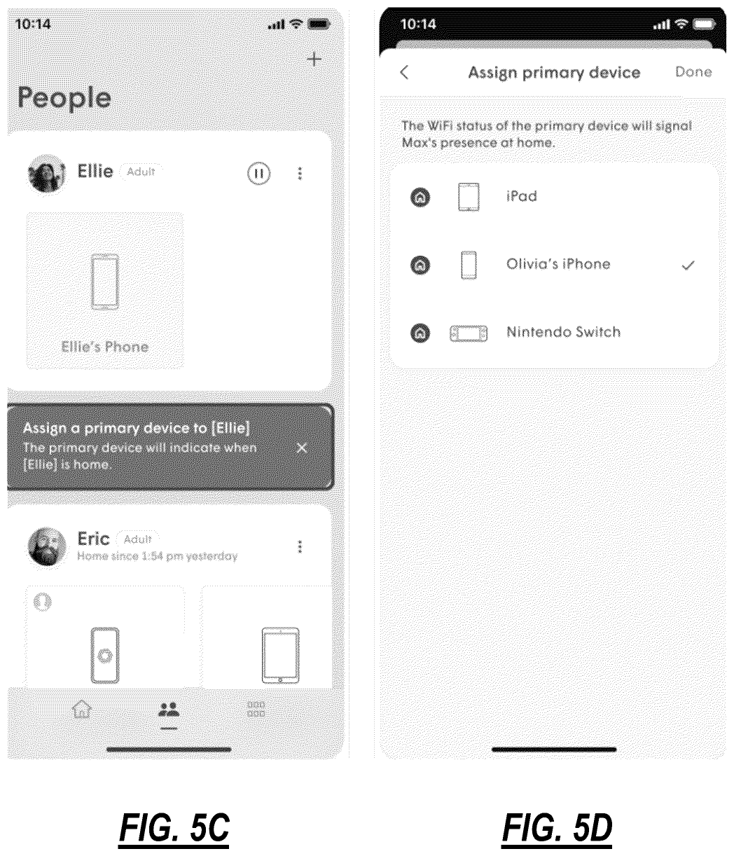

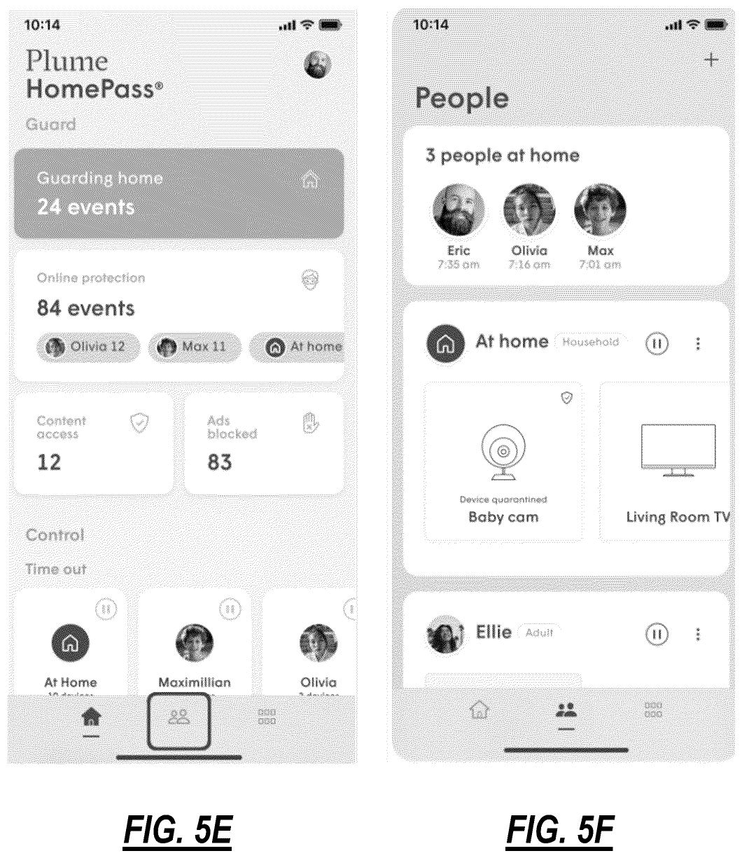

In an embodiment, the Wi-Fi network 10 can support smart motion detection at the location and provide details to the cloud service 40. This can be used to determine when family members or guests arrive or leave as well as activity, which room people are in, and the like. In one approach, the access points 14, 18, 20, 22 can include sensing hardware such as radar. In another approach, the access points 14, 18, 20, 22 can detect disturbances in the Wi-Fi signals and these disturbances in the signal are translated into motion events, which can be used to track activity. FIGS. 5A and 5B are screenshots of the app illustrating a motion configuration graphical user interface (GUI) (FIG. 5A) and a motion visualization GUI (FIG. 5B).

### § 3.3 Users at Home

In another embodiment, the Wi-Fi network 10 and the cloud service 40 can support a “users at home” feature that determines who is currently at the location, including even where (i.e., which room) they are in. This feature can be used in combination with the motion detection as well as standalone. FIGS. 5C and 5D are screenshots of the app illustrating a device assignment process. Each person can have a primary device assigned to their profile, as well as secondary devices. That primary device's connections and disconnections from the network determine if they show up as being at home, which is also important for managing the location via the cloud service 40. The primary device should be chosen based on it being likely to always be with the user and likely always powered on. For example, smartwatches and mobile phones are ideal candidates. The app can notify a user when a new device connects to the Wi-Fi network 10. Further, the app can include a people tab (FIG. 5C). From here, a user can add people and assign a primary device (FIG. 5D).

Of note, the Wi-Fi network 10 and the cloud service 40 can also track these devices even with MAC randomization. For example, see U.S. patent application Ser. No. 17/731,397, filed Apr. 28, 2022, and entitled “Identifying Wi-Fi devices based on user behavior,” the contents of which are incorporated by reference in their entirety, for a discussion on various approaches for tracking devices that randomize their MAC address. Of note, MAC randomization is meant to prevent tracking of users and U.S. patent application Ser. No. 17/731,397 seeks to overcome this. However, it is noted that the techniques in U.S. patent application Ser. No. 17/731,397 require a device to continually connect over time to the Wi-Fi network 10 and the tracking is over time.

Once the primary devices are assigned, tracking is based on when the primary device is connected. These details are shown in FIGS. 5E and 5F which are screenshots of the app illustrating people at home. This tracking can be more granular such as in a distributed Wi-Fi system where it is possible to determine the room based on which access point the primary device is connected. Also, the access points can include radar, ultrawideband (UWB), and the like, which can also be used for location. Even further, the primary devices can be registered with the cloud service 40 and share location such as via global positioning satellite (GPS) or the like.

### § 3.4 Network Operations Center Dashboard

In addition to the mobile app, there is a network operations center (NOC) dashboard, an example of which is described in U.S. patent application Ser. No. 16/897,371, filed Jun. 10, 2020, and entitled “Network operation center dashboard for cloud-based Wi-Fi systems,” the contents of which are incorporated by reference in their entirety. The NOC dashboard can be available via the cloud service 40 and can be used by a service provider (e.g., cable provider, Internet provider), utility companies, etc. There can be segmentation in the NOC dashboard.

### § 4.0 WI-FI NETWORK WITH WIRED AND WIRELESS CONNECTIVITY

Again, the wireless access points 14, 18, 22 include both the Wi-Fi radios 104A, the cellular radios 104B, and the network interface 110. The network interface 110 can include an Ethernet connection to the modem/router 30. In an embodiment, the cellular radios 104B can provide a backup connection to the Ethernet connection, for connectivity to the Internet. Of note, the access point 14, 18, 22 with the cellular radios 104B can be referred to as a gateway 30A node. That is, the term gateway 30A is meant to cover any access point 14, 18, 22, modem/router, etc. or combination thereof that enables connectivity to the Internet 12 for the Wi-Fi network 10. Note, in some embodiments, a modem is separate from the access point 14, 18, 22. In other embodiments, the access point 14, 18, 22, include a router. In still other embodiments, the access point 14, 18, 22 can include a modem/router. Those skilled in the art will recognize various approaches are contemplated and all such equivalents are considered herewith.

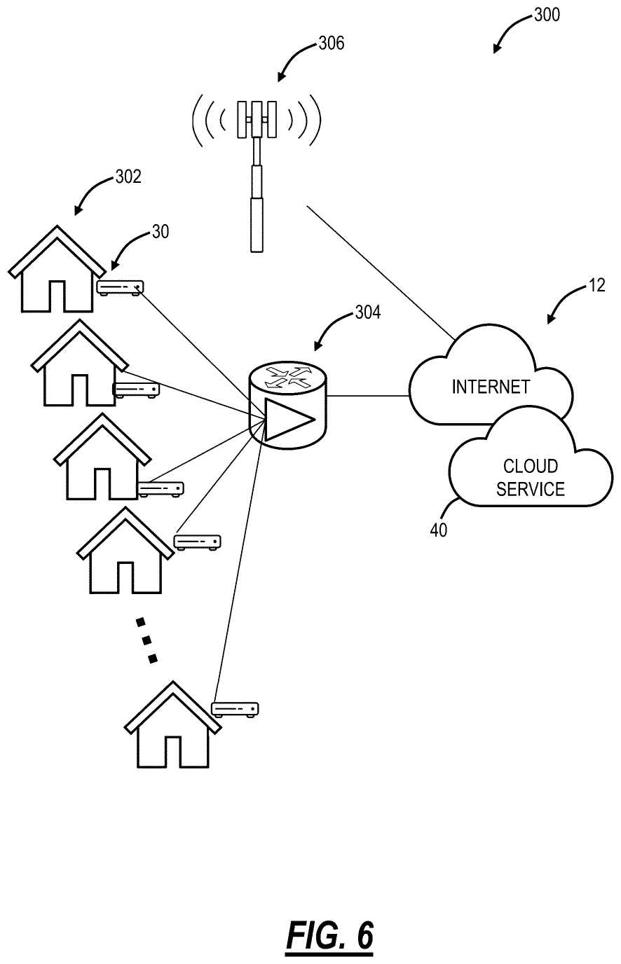

FIG. 6 is a network diagram of a portion of a network 300 associated with a network operator. In this example, the network operator includes both wired and wireless broadband in the same geographical area, represented by homes 302. For example, the wired broadband can be via modems/routers 30 that can connect ultimately to a cable modem termination system (CMTS) 304 (or some other type of wired infrastructure, e.g., DSL, Passive Optical Network (PON), Hybrid Fiber Coax (HFC), etc.), and the wireless broadband can be via fixed wireless access via the cellular radios 104B in the access points 14, 18, 22 that connect to a base station 306 (e.g., eNodeB, gNodeB, etc.). It would be advantageous to support failover to the wireless broadband in the case of a wired broadband failure, providing reliability, uptime, and high service level agreement (SLA) support. In the case of a single outage, this is not an issue on the wireless network. However, often wired failures are geographically localized. For example, failure of the CMTS 304 causes a burden on the base station 306 because the wired broadband failure is geographically localized to the homes 302. This could dramatically put a burden on the base station 306 or other cellular cells in the area, leading to degradation of services for all mobile users in the area. That is, wired broadband outages tend to be localized and using wireless broadband for failover could inundate the cellular network.

### § 4.1 Fixed Wireless Access System

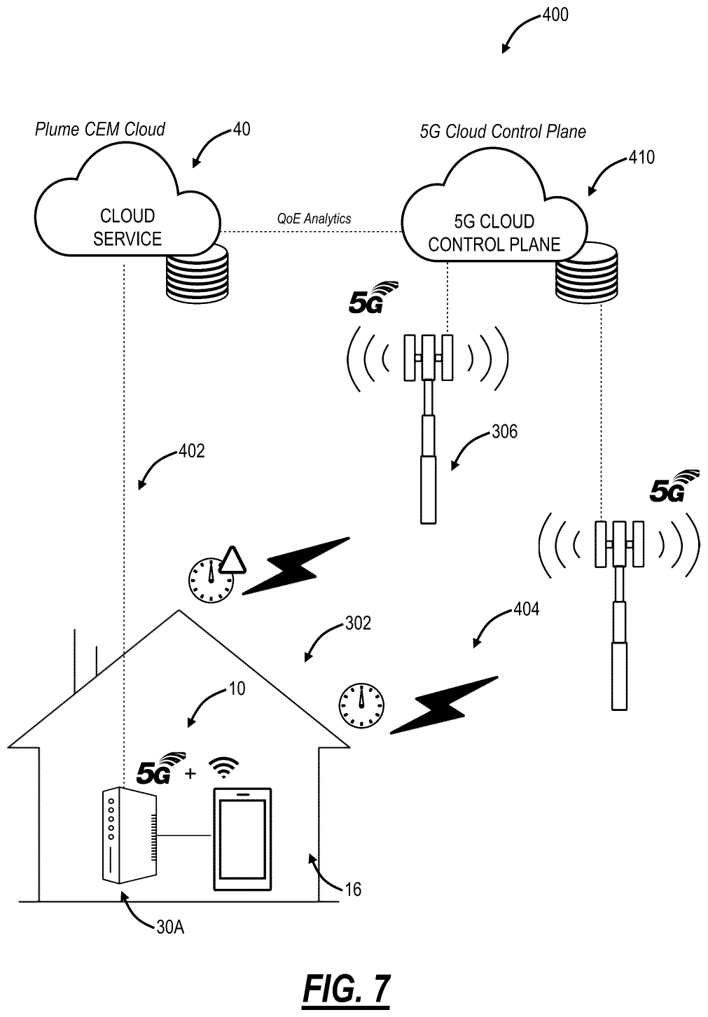

FIG. 7 is a diagram of a fixed wireless access system 400 for wired and/or wireless connectivity. For illustration purposes, the fixed wireless access system 400 is illustrated with a single home 302 having a modem/router 30 and a Wi-Fi client device 16. Those skilled in the art will recognize the fixed wireless access system 400 contemplates multiple locations, including homes, businesses, store, library, mall, sporting area, or any location where a Wi-Fi network 10 is deployed. Further, the fixed wireless access system 400 contemplates use with various different Wi-Fi networks 10, with various different network operators, etc. Also, the fixed wireless access system 400 contemplates use with any of the various wired and/or wireless connectivity schemes described herein.

The cloud service 40 is configured to connect to the Wi-Fi network 10, either via a wired connection 402 and/or a wireless connection 404. In an embodiment, the cloud service 40 can be utilized for configuration, monitoring, and reporting of the Wi-Fi networks 10 in the homes 302 or other locations. The cloud service 40 can be configured to detect outages such as for the wired connections 402. For example, this functionality is described in commonly-assigned U.S. patent application Ser. No. 17/700,782, filed Mar. 22, 2022, and entitled “Intelligent monitoring systems and methods for Wi-Fi Metric-Based ISP Outage Detection for Cloud Based Wi-Fi Networks,” the contents of which are incorporated by reference in their entirety.

Also, the cloud service 40 can connect to a 5G cloud control plane 410 and can determine 5G to Wi-Fi quality of experience (QoE) monitoring and application prioritization controls for increased service consistency. QoE analytics can be shared with 5G cloud control plane 410 for network optimization feedback.

In an embodiment, the access points 14, 18, 20, 22 and/or gateway 30A can include OpenSync support for communicating with the cloud service 40.

### § 5.0 ENERGY EFFICIENCY IN WI-FI NETWORKS AND SMART HOMES

The foregoing sections describe components in smart homes that can be used to gather data and participate in the various techniques described as follows related to energy efficiency. The various techniques and approaches described herein are described with reference to users, i.e., end customers, the cloud service 40, utility companies, hybrid telco/utility companies, CSPs, and the like.

Variously, the present disclosure includes
(1) power savings on devices,
(2) demand response techniques to utilities/CSPs, and
(3) demand response to end customers (users).

### § 6.0 POWER SAVINGS ON SMART DEVICES

The cloud service 40 has vast amounts of data from the middleware layer 150. This can be from the Wi-Fi network 10 as well as from smart devices that use the middleware layer 150. Of course, smart devices do not necessarily need the middleware layer 150, but can be programmed to directly interact with the cloud service 40. In an embodiment, the cloud service 40 can be configured to implement power savings in the Wi-Fi network 10. In another embodiment, the cloud service 40 can be configured to implement power savings in smart devices.

### § 6.1 Power Savings in Wi-Fi Networks

There can be power savings on the access points 14, 18, 20, 22 based on a variety of approaches that can be triggered based on low usage, no usage, high energy demand on the grid, and the like. The approaches contemplate implementation on any of the access points 14, 18, 20, 22, as well as on any smart device having radios. The approaches can include, for example:
(1) turning down radios within the access point and reducing a number of transmitter (Tx) chains.
(2) turning off radios, such as specific bands, e.g., 5 GHz, 6 GHz, and operating on just the 2.4 GHz band.
(3) reducing a rate on any wired (Ethernet) ports, e.g., 2.5 Gb/s to 1 Gb/s or lower.
(4) reducing the frequency of beaconing.
(5) reducing the multiple-input-multiple-output (MIMO) transmit dimension on the radios.
(6) reducing transmit power.
(7) software-based transmit duty cycle.
(8) a quiet timer for duty cycle control
(9) changing network topology.
(10) turning off the Wi-Fi network 10 responsive to detecting an Internet outage.

Of note, details of these approaches are described in commonly-assigned U.S. Pat. No. 11,347,287, issued May 31, 2022, and entitled “Thermal management of wireless access points,” the contents of which are incorporated by reference in their entirety. U.S. Pat. No. 11,347,287 describes these techniques with reference to overheating. The present disclosure extends these techniques to energy conservation. That is, these approaches can be used even if there is no thermal issue.

### § 6.2 Wi-Fi Power Saving Approaches

Example power saving approaches can include one or more of turning off radios, reduce the MIMO transmit dimension on the 2.4G and/or 5G radios, reduce transmit power, software-based transmit duty cycle, a quiet timer for duty cycle control, changing network topology, and the like.

For turning off the radios 104, reducing power, reducing MIMO Tx dimension, etc, this has the advantage of significantly lowering power consumption. It is also useful in a distributed or mesh Wi-Fi network where the network topology can be adjusted to compensate for the reduction. Of note, the power savings can be avoided at a gateway node in a distributed network. The power savings can be implemented at the gateway node when there is a single access point in the Wi-Fi network 10, but only techniques that still enable communications.

With respect to reducing the MIMO transmit dimension, this is a more graceful adaptation than turning off a radio. This approach requires some software to force the driver to queue packets with single stream data rates, and force a single stream Tx chain mask (disable Cyclic Delay Diversity (CDD) type transmissions which put out a single stream from both chains). Switching to single chain reception as well as single chain transmission would save even more power by reducing the power when in a receive mode. However, there are additional complications if dropping to a single chain reception. Once the access point 14 has reduced its MIMO receive dimension, it will not be able to receive packets from Wi-Fi client devices 16 at a MIMO dimension that is larger than what the access point 14 dropped down to. The MIMO dimension the access point 14 can handle is provided to the Wi-Fi client device 16 when the Wi-Fi client device 16 associates to the access point 14. Therefore, if this value is changed dynamically, the Wi-Fi client device will not be aware that the access point 14 can no longer receive full dimension MIMO packets. An access point 14 changing its MIMO dimension would, therefore, need to notify Wi-Fi client devices 16 of the switch. Another approach would be to trust Wi-Fi client devices 16 to adapt well when no dual stream packets succeed. Most Wi-Fi client devices 16 have rate adaptation algorithms that will sense that the full MIMO dimension is not working (the clients will presume it is because of a poor channel) and drop to a lower MIMO dimension automatically.

With respect to reducing transmitter power, reducing the transmitter power on both bands may significantly degrade the throughput on both bands (again a problem for capacity in 5G), and perhaps shorten the range to the point that Wi-Fi client devices 16 and access points 14 can no longer connect. In addition, to get significant power savings, it might require changing the bias currents in the power amplifiers as the requested transmitter power is varied. This would require a change to the driver, and would require significant measurement and characterization of the bias levels required for a given output power level over voltage, temperature, chip to chip, etc.

With respect to the software-based transmit duty cycle, since much of the power comes from the power amplifiers which are used only during transmission, if the duty cycle (percentage of time) of transmission is limited, the power can be reduced. The transmit duty cycle can be limited at a relatively high level in the networking stack, or at the very lowest level as the packets are being delivered to the hardware to be transmitted. While implementation of the high-level software-based duty cycle limitation is less complex, depending on the design of the software system, it may not be effective in controlling the duty cycle. If the software queue inside the driver is quite deep and the data rate is unknown, reliable control of the duty cycle of the radio is not possible. In addition, Transmission Control Protocol (TCP) performance drops quickly when this technique is applied. Another option would be to use the off-channel scanning mechanism to gate the transmitter effectively. When the radio is sent off-channel to scan, it does not transmit, so the transmit duty cycle is reduced. However, off-channel scanning takes the driver away from the channel for both transmit and receive, so this approach can have a serious detriment to network performance.

With respect to a quiet timer for duty cycle control, this approach advantageously controls the queue at the very head through hardware, such as through the IEEE 802.11h quiet time mechanism. This allows reliable control of the Tx duty cycle regardless of the data rate or queue depth. This approach has many advantages. This approach can be implemented in a relatively fine-grained fashion (a range of duty cycles can be supported) so that the throughput/temperature tradeoff can be fine-tuned to optimize performance. This approach does not break any connections, so no topology change is required, and no significant software changes are required in the cloud 12. There is no need to worry about leaving Wi-Fi client devices 16 out of range, or permanently breaking the ability to have access points 14 connect as it does not affect range or band availability, it just reduces throughput. Because the mode switching can be quick and with only localized throughput effect, this approach can move between modes rapidly, allowing hysteresis to be just based on the temperature of the access point, nothing more sophisticated. However, many chipsets do not allow sufficient control of the quiet time mechanism to achieve full transmit duty cycle control. Finally, going into quiet time gates the sending of Acknowledgments (ACKs). This may create a problem for uplink traffic or for TCP ACKs coming back from Wi-Fi client devices 16. Clear-to-Send (CTS) to self is needed, and the quiet periods need to be short (<30 ms) to prevent this, at which point the interval between quiet times must be short to create a significant reduction in duty cycle.

With respect to the network topology, the topology determines which access point 14 connects to which other access points 14. Some access point 14 may be more central in a given topology, and thereby need to carry a higher load of traffic. In particular, an access point 14 may be placed in a “central” role in which it forwards traffic to several other access points 14, each with a set of Wi-Fi client devices 16. A central access point 14 of this type may have a high transmit duty cycle, particularly if the range to some of the downstream access points 14 is large, forcing the use of lower data rates to cover the distance. Moving the same amount of traffic at lower data rates inherently makes the transmit duty cycle higher. Thus, the cloud service 40 can consider the power as a parameter for optimization, e.g., moving higher temperature devices out of the central role, etc. For example, higher powered access points 14 can be optimized to have fewer children to which they must transmit traffic to, to have children with a lower traffic load, and to have fewer children that are at long range.

Also, the cloud service 40 can perform client steering to determine which Wi-Fi client devices 16 associate with the access points 14 in the Wi-Fi network 10. In an embodiment, the Wi-Fi client devices 16 can be steered such that access points 14 which are in power savings mode have fewer Wi-Fi client devices 16, have Wi-Fi client devices 16 with lower loads, have Wi-Fi client devices 16 closer in distance, etc. Also, the cloud service 40 can perform band steering (2.4G vs. 5G vs. 6G) to determine which band the Wi-Fi client devices 16 connect. The cloud service 40 can perform band steering of the Wi-Fi client devices 16 from a radio 104 that is in power savings to a radio 104 which is not in power savings within the access point 14 such that the power savings radio 14 has fewer Wi-Fi client devices 16 connected to it, has Wi-Fi client devices 16 that have lower loads connected to it, has Wi-Fi client devices 16 that are closer to the access point 14 connected to it, etc.

Perhaps the simplest and least impactful to network connectivity power savings technique is to have the Wi-Fi network 10 turn off or low power responsive to an outage.

### § 6.3 Wi-Fi Power Saving Application

The power savings can be applied anytime, such as when there is low use, no use, overnight, when users are away, etc. In an embodiment, power savings can be scheduled, such as from the app. Examples may include every night or some other periodic value, on demand such as when a user is out of town, and the like. The power savings can also be implemented based machine learning where the cloud service 40 keeps track and determines the most likely times to implement the power savings. As noted above, it is possible to identify devices and determine activity. For example, if just stationary devices like IoT, etc. are active, this may mean there is an opportunity for power savings.

Also, the power saving approaches can be combined into different sets. For example, one set of power savings approaches can be “home, but low activity,” another set can be “away, and low activity,” whereas a third set can be “home, but high demand on the grid,” and the like. Those skilled in the art will recognize various approaches are possible.

In another embodiment, the user may have control to override any approach via the app. Also, the utility/CSP can be able to override the override such as if there is a large demand and there may be a blackout.

### § 6.4 Wi-Fi Power Saving Analytics

In an embodiment, it is possible for the cloud service 40 and/or the app to determine power savings achieved via any implemented power savings approaches. This determination can be a straight calculation—the Wi-Fi network 10 utilized power saving approach X for Y minutes, and power saving approach X saves mW/minute, etc. This data can be presented visually in the app. There can also be a settings page enabling the user to more aggressively or more conservatively apply the power savings approaches. This data can also be aggregated by the cloud service 40, e.g., a couple Watts saved per household over time, aggregated by thousands or more households, etc. We can aggregate this by year, month and even across our user base to demonstrate the impact we are making.

### § 7.0 DEMAND RESPONSE

The previous section focused on power savings of devices for a specific user. The cloud service 40 can manage thousands or even millions of locations, Wi-Fi networks 10, etc. Again, the middleware layer 150 allows the cloud service 40 to interact with any capable device, across different vendors. The present disclosure contemplates aggregating the data, analyzing the data, and providing meaningful insights to CSPs, utilities, etc. These meaningful insights can be used for various proactive measures by the CSPs, utilities, etc.

During peak hours, utilities have to acquire more energy to fulfill the needs when their supply runs out or the grid is strained. Unfortunately, utilities do not have detailed visibility for managing demand, and many have blackouts. Utilities have demand response where they tell users to conserve power and if they are not able to, a blackout happens.

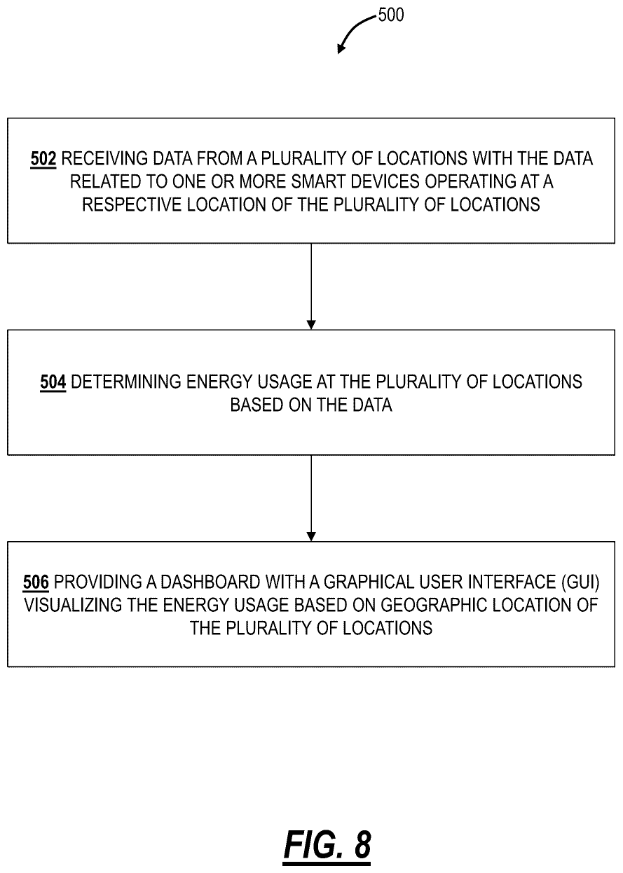

FIG. 8 is a flowchart of a process 500 for providing analytics related to energy consumption. The process 500 contemplates implementation as a method having steps, via a processing device with one or more processors configured to implement the steps, via the cloud service 40 implementing the steps, and/or as a non-transitory computer-readable medium storing instructions that, when executed, cause one or more processors to implement the steps.

The process 500 includes receiving data from a plurality of locations with the data related to one or more smart devices operating at a respective location of the plurality of locations (step 502); determining energy usage at the plurality of locations based on the data (step 504); and providing a dashboard with a graphical user interface (GUI) visualizing the energy usage based on geographic location of the plurality of locations (step 506).

The data can further include a device type of the one or more smart devices with the device type determined by a local network at the respective location. This can enable visualization of where certain smart devices are located. For example, this enables utilities or the like to target messages to certain users or user profiles (e.g., people with electric vehicles, heat pumps, etc.). This can also allow automated switching off of these devices with IoT control.

The process 500 can include providing a visualization based on the device type of the one or more smart devices, in a determined region based on the geographic location. The process 500 can include automatically adjusting power or turning off any of the one or more smart devices based on a given device type. The process 500 can include utilizing the device type of the one or more smart devices to provide messages to associated users, with the messages including instructions or recommendations. The process 500 can include determining power savings based on the messages to associated users and providing a visualization of the power savings to determine engagement. The geographic location can be based on grid zones.

The process 500 can include causing the one or more smart devices to implement power savings approaches. The process 500 can be implemented by a cloud service and the receiving is from a Wi-Fi network.

The determining can further include estimating additional energy usage based on non-smart devices at the plurality of locations or based on additional locations. Of note, this can provide better results as not all devices may be included in the data. Of course, more and more devices are becoming smart devices. Also, the receiving can be from a meter having middleware installed thereon. From this, it is possible to correlate overall energy usage based on the smart device energy usage.

The process 500 can include receiving consent from a given user associated with a given location, the consent for any of turning off the one or more smart devices, for reducing power to the one or more smart devices, and time windows for participation; and controlling the one or more smart devices based on the consent.

The process 500 can include communicating to an application on a user device of a given user associated with a given location; and providing a dashboard in the application providing energy usage at the given location. The process 500 can include receiving preferences from the given user via the application.

Advantageously, the dashboard can be used by CSPs or utilities within a specific grid zone. This dashboard can drill down to a specific household/location which can be sortable based on energy usage. On the dashboard, users can also filter on certain device to deliver campaign messages to a certain group, and see the number of users the message is going out to. The dashboard can also see how many of the sent out messages have gotten engagement.

The dashboard can also provide real time usage data and aggregated number of users enrolled. Home users can see their usage information on their application.

It is also possible to present, on the dashboard and/or on the application, visualizations of peak hours and rates associated. In an embodiment, users can see when dirty (fossil fuel-based) versus clean energy (wind, solar, nuclear, etc.) is being used. This can be determined based on data from the utility or based on a calculation based on data from the utility. Also, the user can set the power savings approaches based on the distribution of dirty versus clean energy. For example, perform more power saving approaches when there is more dirty energy being used.

The users can see what campaigns are being sent to them, and choose to opt in or out (e.g., during peak hours, I agree to let utility take control and turn down my thermostat, I agree to let utility switch off my EV). Home users can set their preferences on when they want to enroll in the programs, e.g., consent to turning off device if dirty energy is being used, consent to only participating in programs at certain times, e.g., 10 pm-6 am.

In another embodiment, there can be a program marketplace where incentives are offered to users for participating in a certain program. The more dire the situation, the incentive can be higher, if many people participate and the situation is not as bad anymore, incentive lessens.

In another embodiment, to curb energy usage, the present disclosure can leverage what connected devices people have, and know if those are energy efficient or not. It is possible to profile who has connected devices or not, to know who may be more likely to buy energy efficient product.

It is possible to target these users to participate in energy efficiency programs (utilities have these today), e.g., give rebates to customers who buy say an energy efficient fridge. Also, we can provide a quick easy interface, where there is a quick REDEEM button next to the device itself or somewhere in the app, where we can either purchase the product for them, or they redeem the code from the utility to aid in quick conversion.

### § 8.0 CONCLUSION

It will be appreciated that some exemplary embodiments described herein may include one or more generic or specialized processors (“one or more processors”) such as microprocessors; Central Processing Units (CPUs); Digital Signal Processors (DSPs): customized processors such as Network Processors (NPs) or Network Processing Units (NPUs), Graphics Processing Units (GPUs), or the like; Field Programmable Gate Arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more Application-Specific Integrated Circuits (ASICs), in which each function or some combinations of certain of the functions are implemented as custom logic or circuitry. Of course, a combination of the aforementioned approaches may be used. For some of the exemplary embodiments described herein, a corresponding device in hardware and optionally with software, firmware, and a combination thereof can be referred to as “circuitry configured or adapted to,” “logic configured or adapted to,” etc. perform a set of operations, steps, methods, processes, algorithms, functions, techniques, etc. on digital and/or analog signals as described herein for the various exemplary embodiments.

Moreover, some exemplary embodiments may include a non-transitory computer-readable storage medium having computer readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), Flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various exemplary embodiments.

The foregoing sections include headers for various embodiments and those skilled in the art will appreciate these various embodiments may be used in combination with one another as well as individually. Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims.

What is claimed is:

1. A method comprising:
receiving data from a plurality of locations with the data related to one or more smart devices operating at a respective location of the plurality of locations;
determining energy usage at the plurality of locations based on the data; and
providing a dashboard with a graphical user interface (GUI) visualizing the energy usage based on geographic location of the plurality of locations.

2. The method of claim 1, wherein the data further includes a device type of the one or more smart devices with the device type determined by a local network at the respective location.

3. The method of claim 2, further comprising:
providing a visualization based on the device type of the one or more smart devices, in a determined region based on the geographic location.

4. The method of claim 2, further comprising:
automatically adjusting power or turning off any of the one or more smart devices based on a given device type.

5. The method of claim 2, further comprising:
utilizing the device type of the one or more smart devices to provide messages to associated users, with the messages including instructions or recommendations.

6. The method of claim 5, further comprising:
determining power savings based on the messages to associated users and providing a visualization of the power savings to determine engagement.

7. The method of claim 1, wherein the geographic location is based on grid zones.

8. The method of claim 1, further comprising:
causing the one or more smart devices to implement power savings approaches.

9. The method of claim 1, wherein the method is implemented by a cloud service and the receiving is from a Wi-Fi network.

10. The method of claim 1, wherein the determining further includes estimating additional energy usage based on non-smart devices at the plurality of locations or based on additional locations.

11. The method of claim 1, wherein the receiving is from a meter having middleware installed thereon.

12. The method of claim 1, further comprising:
receiving consent from a given user associated with a given location, the consent for any of turning off the one or more smart devices, for reducing power to the one or more smart devices, and time windows for participation; and
controlling the one or more smart devices based on the consent.

13. The method of claim 1, further comprising:
communicating to an application on a user device of a given user associated with a given location; and
providing a dashboard in the application providing energy usage at the given location.

14. The method of claim 13, further comprising:
receiving preferences from the given user via the application.

15. A non-transitory computer-readable medium comprising instructions that, when executed, cause one or more processors to perform steps of:
receiving data from a plurality of locations with the data related to one or more smart devices operating at a respective location of the plurality of locations;
determining energy usage at the plurality of locations based on the data; and
providing a dashboard with a graphical user interface (GUI) visualizing the energy usage based on geographic location of the plurality of locations.

16. The non-transitory computer-readable medium of claim 15, wherein the data further includes a device type of the one or more smart devices with the device type determined by a local network at the respective location.

17. The non-transitory computer-readable medium of claim 16, wherein the steps further include:
providing a visualization based on the device type of the one or more smart devices, in a determined region based on the geographic location.

18. The non-transitory computer-readable medium of claim 16, wherein the steps further include:
automatically adjusting power or turning off any of the one or more smart devices based on a given device type.

19. The non-transitory computer-readable medium of claim 16, wherein the steps further include:
utilizing the device type of the one or more smart devices to provide messages to associated users, with the messages including instructions or recommendations.

20. The non-transitory computer-readable medium of claim 15, wherein the steps further include:
causing the one or more smart devices to implement power savings approaches.
